(19) United States
(12) Patent Application Publication
(10) Pub. No.: US 2023/0409921 A1
(43) Pub. Date: Dec. 21, 2023

(54) MULTI-NODE DISTRIBUTED TRAINING METHOD AND APPARATUS, DEVICE AND READABLE MEDIUM

(71) Applicant: INSPUR SUZHOU INTELLIGENT TECHNOLOGY CO., LTD., Suzhou, Jiangsu (CN)

(72) Inventors: Lianshui ZHAO, Jinan, Shandong (CN); Shaohua WU, Jinan, Shandong (CN)

(21) Appl. No.: 18/035,489

(22) PCT Filed: Sep. 28, 2021
(86) PCT No.: PCT/CN2021/121433

§ 371 Date: May 4, 2023

(30) Foreign Application Priority Data
Nov. 28, 2020 (CN) 202011362143.9

(51) Int. Cl. G06N 3/098; G06N 3/063

(52) U.S. Cl. CPC G06N 3/098; G06N 3/063

(57) ABSTRACT

The present application discloses a method for multi-node distributed training. The method includes: in each of nodes, establishing an independent training calculation chart, covering all of GPUs and CPUs in each of the nodes by using the training calculation chart, and adding the CPUs of each of the nodes into a deep-learning-model distributed-training frame; copying initial training parameters in GPUs of a host node into CPUs of the host node, and sending the initial training parameters in the CPUs of the host node to the CPUs of other nodes; copying the initial training parameters received by the CPUs of the other nodes into GPUs of the respective nodes, performing a protocolling operation to a gradient by using the training calculation chart, and copying a first-level gradient obtained after the protocolling into CPUs of the respective nodes; and performing protocolling again to the first-level gradient in the CPUs of the respective nodes, and copying a second-level gradient obtained after the protocolling into the GPUs of the respective nodes. The present application further discloses the corresponding apparatus, computer device and readable storage medium. The present application, by combining the advantages of the two training modes of Horovod and Replicated, increases the training efficiency.

The present application claims the priority of the Chinese patent application filed on Nov. 28^{th}, 2020 before the Chinese Patent Office with the application number of 202011362143.9 and the title of “MULTI-NODE DISTRIBUTED TRAINING METHOD AND APPARATUS, DEVICE AND READABLE MEDIUM”, which is incorporated herein in its entirety by reference.

### FIELD

The present application relates to the technical field of storage, and particularly relates to a method and apparatus for multi-node distributed training, a device, and a readable medium.

### BACKGROUND

Deep-learning-model training is an important step for the practical application of artificial-intelligence products. With the expansion of the training data and the model structure, the application of calculation accelerators (for example, NVIDIA GPUs) in deep-learning-model training is and will be a popular trend. Moreover, the large-scale distributed training also highly accelerates the training of deep-learning models. For example, when a single NVIDIA NGX-2 node (including 16 V100GPUs) is used, the model bert_large costs 3 days. When 16 DGX-2 nodes are used, it costs 4 hours. When 64 DGX-2 nodes are used, it costs 67 minutes.

In distributed training, a commonly used distributed-training frame is Horovod, which has two functions: unifying the training parameters before the training, and performing a protocolling operation to the gradients in each of the steps of the training. Because of its conciseness in usage and excellent expansibility, Horovod is very popular in distributed training, but the comparison between it and other methods in terms of the performances has not been studied yet. The latest single-node test demonstrates that, in 8 NVIDIA GPU-T4s, the performances of Horovod and Replicated have on obvious difference, while in 8 GPU-V100s of a higher calculation power, the performance of Replicated may be higher than that of Horovod by 30%.

A first related art includes that each of the GPUs in each of the nodes has the same training calculation chart, the GPUs are controlled by different processes, and before the training starts, the training parameters of all of the GPUs are unified by using a broadcasting operation of Horovod. In each of the steps of the training, each of the GPUs calculates out the respective gradient, and the gradients in all of the GPUs are protocolled by using an allreduce operation in Horovod, to realize that each of the GPUs obtains the same protocolled gradient. The disadvantage of the first related art is that, with the expansion of the distribution scale, the performance of a single GPU decreases very quickly, and its expansibility deteriorates. For example, in a GPU-V100, the performance of Replicated may be higher than that of Horovod by 30%.

A second related art is a Replicated training mode, i.e., establishing one training calculation chart in each of the nodes, which covers all of the GPUs in this node. In each of the steps of the training, the protocolling of the gradients of the GPUs may be operated in two modes. One mode is add n, i.e., in each of the GPUs, copying all of the gradients of the other GPUs to the GPU itself, and subsequently solving the sum or the average of them. The other mode is to perform protocolling by using ncclallreduce in the GPUs. The disadvantage of the second related art is that, in the case of large-scale distribution, for example, more than 1000 nodes, when add n is used to perform protocolling to the gradients, the graphic memory in a single GPU might be insufficient, and when ncclallreduce is used to perform protocolling, in certain cases, its performance is inferior to that of add n.

### SUMMARY

In view of the above, an object of the embodiments of the present application is to provide a method and apparatus for multi-node distributed training, a device and a readable medium. By combining the advantages of the two training modes of Horovod and Replicated, in a single node the distributed-training mode of Replicated is used to obtain a higher performance, and, between the nodes, Horovod is used to overcome the problem that, when the node quantity increases, Replicated results in an insufficient graphic memory of a single GPU.

In order to achieve the above object, an aspect of the embodiments of the present application provides a method for multi-node distributed training, and the method includes:
in each of nodes, establishing an independent training calculation chart, covering all of GPUs and CPUs in each of the nodes by using the training calculation chart, and adding the CPUs of each of the nodes into a deep-learning-model distributed-training frame;
copying initial training parameters in GPUs of a host node into CPUs of the host node, and based on a broadcasting operation of the deep-learning-model distributed-training frame, sending the initial training parameters in the CPUs of the host node to CPUs of other nodes;
copying the initial training parameters received by the CPUs of the other nodes into GPUs of the respective nodes, performing a protocolling operation to a gradient by using the training calculation chart, and copying a first-level gradient obtained after the protocolling into the CPUs of the respective nodes; and
based on a global protocolling operation of the deep-learning-model distributed-training frame, performing protocolling again to the first-level gradient in the CPUs of the respective nodes, and copying a second-level gradient obtained after the protocolling into the GPUs of the respective nodes.

In some embodiments, the operation of, in each of the nodes, establishing the independent training calculation chart, covering all of the GPUs and the CPUs in each of the nodes by using the training calculation chart includes:
in each of the nodes, establishing an independent calculation chart in a form of Replicated, and covering all of the GPUs and the CPUs in each of the nodes by using the calculation chart.

In some embodiments, the operation of adding the CPUs of each of the nodes into the deep-learning-model distributed-training frame includes:
adding the CPUs of each of the nodes into a Horovod training frame.

In some embodiments, the operation of performing the protocolling operation to the gradient by using the training calculation chart includes:
solving a sum or an average value of gradients of all of the GPUs in the node.

In some embodiments, the operation of performing the protocolling operation to the gradient by using the training calculation chart includes:
invoking a protocolling operation in a GPU communication library, and based on the protocolling operation, solving a sum or an average of gradients.

Another aspect of the embodiments of the present application further provides an apparatus for multi-node distributed training, and the apparatus includes:
an initializing module configured for, in each of nodes, establishing an independent training calculation chart, covering all of GPUs and CPUs in each of the nodes by using the training calculation chart, and adding the CPUs of each of the nodes into a deep-learning-model distributed-training frame;
a broadcasting module configured for copying initial training parameters in GPUs of a host node into CPUs of the host node, and based on a broadcasting operation of the deep-learning-model distributed-training frame, sending the initial training parameters in the CPUs of the host node to CPUs of other nodes;
a first-level protocolling module configured for copying the initial training parameters received by the CPUs of the other nodes into GPUs of the respective nodes, performing a protocolling operation to a gradient by using the training calculation chart, and copying a first-level gradient obtained after the protocolling into CPUs of the respective nodes; and
a second-level protocolling module configured for, based on a global protocolling operation of the deep-learning-model distributed-training frame, performing protocolling again to the first-level gradient in the CPUs of the respective nodes, and copying a second-level gradient obtained after the protocolling into the GPUs of the respective nodes.

In some embodiments, the initializing module is further configured for:
in each of the nodes, establishing an independent calculation chart in a form of Replicated, and covering all of the GPUs and the CPUs in each of the nodes by using the calculation chart.

In some embodiments, the initializing module is further configured for:
adding the CPUs of each of the nodes into a Horovod training frame.

Yet another aspect of the embodiments of the present application further provides an computer device, and the computer device includes:
at least one processor; and
a memory, wherein the memory stores a computer instruction that is executable in the processor, and the instruction, when executed by the processor, implements the operations of the method stated above.

Still another aspect of the embodiments of the present application further provides a computer-readable storage medium, and the computer-readable storage medium stores a computer program that, when executed by a processor, implements the operations of the method stated above.

The present application has the following advantageous technical effect. By combining the advantages of the two training modes of Horovod and Replicated, in a single node the distributed-training mode of Replicated is used to obtain a higher performance, and, between the nodes, Horovod is used to overcome the problem that, when the node quantity increases, Replicated results in an insufficient graphic memory of a single GPU.

### BRIEF DESCRIPTION OF THE DRAWINGS

In order to more clearly illustrate the technical solutions of the embodiments of the present application or the related art, the figures that are required to describe the embodiments or the prior art will be briefly described below. Apparently, the figures that are described below are merely embodiments of the present application, and a person skilled in the art may obtain other embodiments according to these figures without paying creative work.

FIG. 1 is a schematic diagram of an embodiment of a method for multi-node distributed training according to the present application;

FIG. 2 is a schematic diagram of an embodiment of an apparatus for multi-node distributed training according to the present application;

FIG. 3 is a schematic diagram of an embodiment of a computer device according to the present application; and

FIG. 4 is a schematic diagram of an embodiment of a computer-readable storage medium according to the present application.

### DETAILED DESCRIPTION

In order to make the objects, the technical solutions and the advantages of the present application clearer, the embodiments of the present application will be further described in detail with reference to the particular embodiments and the drawings.

It should be noted that all of the expressions using “first” and “second” in the embodiments of the present application are intended to distinguish two different entities or different parameters that have the same names. It can be seen that “first” and “second” are merely for the convenience of the expression, and should not be construed as a limitation on the embodiments of the present application, which will not be explained in detail in the subsequent embodiments.

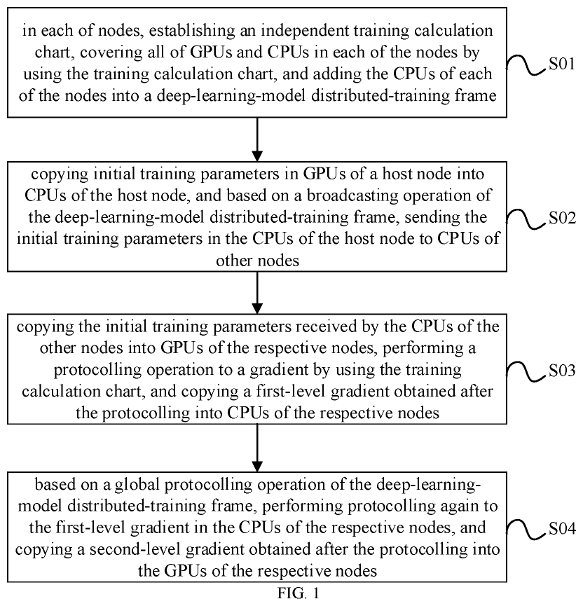

In order to achieve the above object, the first aspect of the embodiments of the present application provides the embodiments of a method for multi-node distributed training. FIG. 1 shows a schematic diagram of an embodiment of a method for multi-node distributed training according to the present application. As shown in FIG. 1, the embodiment of the present application includes the following steps executed at the side of a maintenance device:
S01: in each of nodes, establishing an independent training calculation chart, covering all of GPUs and CPUs in each of the nodes by using the training calculation chart, and adding the CPUs of each of the nodes into a deep-learning-model distributed-training frame;
S02: copying initial training parameters in GPUs of a host node into CPUs of the host node, and based on a broadcasting operation of the deep-learning-model distributed-training frame, sending the initial training parameters in the CPUs of the host node to CPUs of other nodes;
S03: copying the initial training parameters received by the CPUs of the other nodes into GPUs of the respective nodes, performing a protocolling operation to a gradient by using the training calculation chart, and copying a first-level gradient obtained after the protocolling into CPUs of the respective nodes; and
S04: based on a global protocolling operation of the deep-learning-model distributed-training frame, performing protocolling again to the first-level gradient in the CPUs of the respective nodes, and copying a second-level gradient obtained after the protocolling into the GPUs of the respective nodes.

In the present embodiment, Replicated is a deep-learning-model distributed-training method, in which in each of the calculation accelerators, all of the calculation charts are the same, and include a respective set of training parameters, and the sum of the calculation charts of each of the calculation accelerators forms one complete calculation chart. Horovod is a deep-learning-model distributed-training frame, and it ensures that all of the calculation accelerators have the same training parameters, and coordinates the gradients of each of the calculation accelerators to perform a protocolling operation.

In the present embodiment, the first part includes, in each of the nodes, establishing an independent calculation chart in the form of Replicated. In other words, all of the GPUs in the nodes are covered by one training calculation chart, and the gradients in each of the GPUs are realized by using add n or ncclallreduce. The add n refers to, in each of the GPUs, copying all of the gradients of the other GPUs in the same node to this GPU, and solving the sum or the average of them. The ncclallreduce refers to, by invoking the protocolling operation in a GPU communication library, solving the sum or the average of the gradients. The second part includes the initialization of the same training parameters, including copying the initial training parameters of the GPUO in a node 0 to the CPUs of the node 0, and by using a broadcasting operation of Horovod, broadcasting those parameters into the CPUs of the other nodes; and copying the parameters of the CPUs in the respective nodes into all of the GPUs in the respective nodes. The third part includes, in each of the steps of the training process, repeating the following operations: in each of the nodes, performing a protocolling operation to the gradients by using the mode (add n or ncclallreduce) in the Replicated calculation chart, and finally copying the gradients obtained after the protocolling in the GPUO into the CPUs; by using an allreduce operation in Horovod, performing protocolling again to the gradients obtained after the protocolling in the CPUs of each of the nodes; and in each of the nodes, copying the gradient values obtained after the protocolling by using Horovod into all of the GPUs.

In some embodiments of the present application, the operation of, in each of the nodes, establishing the independent training calculation chart, covering all of the GPUs and the CPUs in each of the nodes by using the training calculation chart includes:

in each of the nodes, establishing an independent calculation chart in a form of Replicated, and covering all of the GPUs and the CPUs in each of the nodes by using the calculation chart.

In some embodiments of the present application, the operation of adding the CPUs of each of the nodes into the deep-learning-model distributed-training frame includes:
adding the CPUs of each of the nodes into a Horovod training frame.

In some embodiments of the present application, the operation of performing the protocolling operation to the gradient by using the training calculation chart includes:
solving a sum or an average value of gradients of all of the GPUs in the node.

In some embodiments of the present application, the operation of performing the protocolling operation to the gradient by using the training calculation chart includes:
invoking a protocolling operation in a GPU communication library, and based on the protocolling operation, solving a sum or an average of gradients.

In some embodiments of the present application, the method is suitable for all of deep-learning frames, including Tensorflow, Pytorch and MxNet, and suitable for all of accelerators for accelerating the training of deep-learning models, including other ASICs such as GPU and TPU.

It should be particularly noted that all of the operations according to the embodiments of the method for multi-node distributed training stated above may be mutually mixed, replaced, added and deleted. Therefore, those reasonable arrangements, combinations and variations of the method for multi-node distributed training should also fall within the protection scope of the present application, and the protection scope of the present application should not be limited to the embodiments.

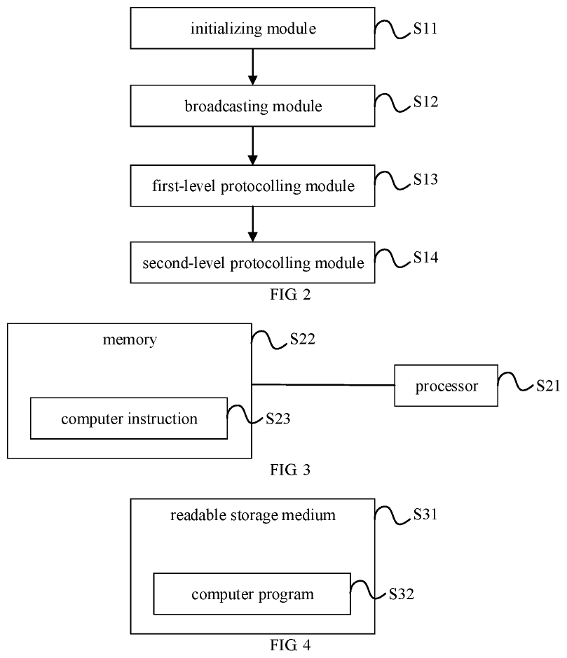

In order to achieve the above object, the second aspect of the embodiments of the present application provides an apparatus for multi-node distributed training. FIG. 2 shows a schematic diagram of an embodiment of an apparatus for multi-node distributed training according to the present application. As shown in FIG. 2, the embodiment of the present application includes the following modules:
an initializing module S11 configured for, in each of nodes, establishing an independent training calculation chart, covering all of GPUs and CPUs in each of the nodes by using the training calculation chart, and adding the CPUs of each of the nodes into a deep-learning-model distributed-training frame;
a broadcasting module S12 configured for copying initial training parameters in GPUs of a host node into CPUs of the host node, and based on a broadcasting operation of the deep-learning-model distributed-training frame, sending the initial training parameters in the CPUs of the host node to CPUs of other nodes;
a first-level protocolling module S13 configured for copying the initial training parameters received by the CPUs of the other nodes into GPUs of the respective nodes, performing a protocolling operation to a gradient by using the training calculation chart, and copying a first-level gradient obtained after the protocolling into CPUs of the respective nodes; and
a second-level protocolling module S14 configured for, based on a global protocolling operation of the deep-learning-model distributed-training frame, performing protocolling again to the first-level gradient in the CPUs of the respective nodes, and copying a second-level gradient obtained after the protocolling into the GPUs of the respective nodes.

In some embodiments of the present application, the initializing module S11 is further configured for:
in each of the nodes, establishing an independent calculation chart in a form of Replicated, and covering all of the GPUs and the CPUs in each of the nodes by using the calculation chart.

In some embodiments of the present application, the initializing module S11 is further configured for:
adding the CPUs of each of the nodes into a Horovod training frame.

In order to achieve the above object, the third aspect of the embodiments of the present application provides a computer device. FIG. 3 shows a schematic diagram of an embodiment of a computer device according to the present application. As shown in FIG. 3, the embodiment of the present application includes the following components: at least one processor 521; and a memory S22, the memory S22 stores a computer instruction S23 that is executable in the processor, and the instruction, when executed by the processor, implements the operations of the method stated above.

The present application further provides a computer-readable storage medium. FIG. 4 shows a schematic diagram of an embodiment of a computer-readable storage medium according to the present application. As shown in FIG. 4, the computer-readable storage medium S31 stores a computer program S32 that, when executed by a processor, implements the method stated above.

Finally, it should be noted that a person skilled in the art may understand that all or some of the processes of the methods according to the above embodiments may be implemented by relative hardware according to an instruction from a computer program, the program of the method for multi-node distributed training may be stored in a computer-readable storage medium, and the program, when executed, may contain the processes of the embodiments of the method stated above. The storage medium of the program may be a diskette, an optical disk, a Read-Only Memory (ROM), a Random Access Memory (RAM) and so on. The embodiments of the computer program may reach an effect the same as or similar to those of any of the above-described process embodiments corresponding thereto.

Furthermore, the method according to the embodiments of the present application may also be implemented as a computer program executed by a processor, the computer program may be stored in a computer-readable storage medium. The computer program, when executed by the processor, executes the above-described functions defined in the method according to the embodiments of the present application.

Furthermore, the above-described method steps and system units may also be implemented by using a controller and a computer-readable storage medium that is used to store a computer program enabling the controller to execute the functions of the steps or units.

A person skilled in the art should also understand that various illustrative logical blocks, modules, electric circuits and algorithm steps described with reference to the disclosure herein may be embodied as electronic hardware, computer software or a combination thereof. In order to clearly explain the interchangeability between the hardware and the software, it has be described generally with reference to the functions of various illustrative components, blocks, modules, electric circuits and steps. Whether those functions are embodied as software or hardware depends on the particular applications and the design constraints exerted on the entire system. A person skilled in the art may employ different modes to implement the functions with respect to each of the particular applications, but those implementation decisions should not be considered as leading to departing from the scope disclosed by the embodiments of the present application.

In one or more exemplary configurations, the functions may be implemented in hardware, software, firmware or any combination thereof. When implemented in software, the functions may be stored in a computer-readable medium as one or more instructions or codes or transmitted via a computer-readable medium. The computer-readable medium includes a computer storage medium and a communication medium, the communication medium includes any medium that facilitates to transmit the computer program from one location to another location. The storage medium may be any available medium that may be accessed by a generic or dedicated computer. As an example rather than limitative, the computer-readable medium may include an RAM, an ROM, an EEPROM, a CD-ROM or another optical-disk storage device, and a magnetic-disk storage device or another magnetic storage device, or is any other medium that may be used to carry or store a program code in the form of a instruction or required by the data structure and may be accessed by a generic or dedicated computer or a generic or dedicated processor. Furthermore, any connection may be suitably referred to as a computer-readable medium. For example, when a coaxial cable, an optical-fiber cable, a twisted pair, a digital subscriber line (DSL) or a wireless technique such as infrared, radio and microwave is used to send software from a website, a server or another remote source, then all of the coaxial cable, the optical-fiber cable, the twisted pair, the DSL or the wireless technique such as infrared, radio and microwave are encompassed within the definition of the medium. As used herein, the magnetic disk and the optical disk include a compact disk (CD), a laser disk, an optical disk, a Digital Video Disk (DVD), a floppy disk and a blue-ray disk, the magnetic disk usually magnetically reproduces data, and the optical disk optically reproduces data by using laser. The combination of the above contents should also be encompassed within the scope of the computer-readable medium.

The illustrative embodiments disclosed by the present application are described above. However, it should be noted that many variations and modifications may be made without departing from the scope of the embodiments of the present application defined by the claims. The functions, steps and/or acts of the process claims according to the disclosed embodiments described herein are not required to be implemented in any specific sequence. Furthermore, although the elements of the embodiments of the present application may be described or claimed in a singular form, unless explicitly limited as singular, they may also be comprehended as plural.

It should be understood that, as used herein, unless the context clearly supports an exception, the singular form “a” is intended to encompass a plural form. It should also be understood that, as used herein, the “and/or” refers to including any and all feasible combinations of one or more relatively listed items.

The serial numbers of the embodiments of the present application are merely for the purpose of description, and do not indicate the relative preferences of the embodiments.

A person skilled in the art may understand that all or some of the steps for implementing the above embodiments may be completed by hardware, and may also be completed by using a program to instruct relevant hardware. The program may be stored in a computer-readable storage medium. The above-mentioned storage medium may be a read-only memory, a magnetic disk, an optical disk and so on.

A person skilled in the art should understand that the discussion on any of the above embodiments is merely illustrative, and are not intended to imply that the scope (including the claims) of the embodiments of the present application is limited to those examples. With the concept of the embodiments of the present application, the embodiments or the technical features of different embodiments may be combined, and many other variations of different aspects of the embodiments of the present application as stated above may exist, which are not provided in detail for brevity. Therefore, any omissions, modifications, equivalent substitutions and improvements that are made within the spirit and the principle of the embodiments of the present application should fall within the protection scope of the embodiments of the present application.

1. A method for multi-node distributed training, wherein the method comprises:
in each of nodes, establishing an independent training calculation chart, covering all of GPUs and CPUs in each of the nodes by using the training calculation chart, and adding the CPUs of each of the nodes into a deep-learning-model distributed-training frame;
copying initial training parameters in GPUs of a host node into CPUs of the host node, and based on a broadcasting operation of the deep-learning-model distributed-training frame, sending the initial training parameters in the CPUs of the host node to CPUs of other nodes;
copying the initial training parameters received by the CPUs of the other nodes into GPUs of the respective nodes, performing a protocolling operation to a gradient by using the training calculation chart, and copying a first-level gradient obtained after the protocolling into CPUs of the respective nodes; and
based on a global protocolling operation of the deep-learning-model distributed-training frame, performing protocolling again to the first-level gradient in the CPUs of the respective nodes, and copying a second-level gradient obtained after the protocolling into the GPUs of the respective nodes.

2. The method for multi-node distributed training according to claim 1, wherein the operation of, in each of the nodes, establishing the independent training calculation chart, covering all of the GPUs and the CPUs in each of the nodes by using the training calculation chart comprises:
in each of the nodes, establishing an independent calculation chart in a form of Replicated, and covering all of the GPUs and the CPUs in each of the nodes by using the calculation chart.

3. The method for multi-node distributed training according to claim 1, wherein the operation of adding the CPUs of each of the nodes into the deep-learning-model distributed-training frame comprises:
adding the CPUs of each of the nodes into a Horovod training frame.

4. The method for multi-node distributed training according to claim 1, wherein the operation of performing the protocolling operation to the gradient by using the training calculation chart comprises:
solving a sum or an average value of gradients of all of the GPUs in the node.

5. The method for multi-node distributed training according to claim 1, wherein the operation of performing the protocolling operation to the gradient by using the training calculation chart comprises:
invoking a protocolling operation in a GPU communication library, and based on the protocolling operation, solving a sum or an average of gradients.

6. (canceled)

7. (canceled)

8. (canceled)

9. A computer device, wherein the computer device comprises:
at least one processor; and
a memory, wherein the memory stores a computer instruction that is executable in the processor, and the instruction, when executed by the processor, causes the processor to:
in each of nodes, establish an independent training calculation chart, cover all of GPUs and CPUs in each of the nodes by using the training calculation chart, and add the CPUs of each of the nodes into a deep-learning-model distributed-training frame;
copy initial training parameters in GPUs of a host node into CPUs of the host node, and based on a broadcasting operation of the deep-learning-model distributed-training frame, send the initial training parameters in the CPUs of the host node to CPUs of other nodes;
copy the initial training parameters received by the CPUs of the other nodes into GPUs of the respective nodes, perform a protocolling operation to a gradient by using the training calculation chart, and copy a first-level gradient obtained after the protocolling into CPUs of the respective nodes; and
based on a global protocolling operation of the deep-learning-model distributed-training frame, perform protocolling again to the first-level gradient in the CPUs of the respective nodes, and copy a second-level gradient obtained after the protocolling into the GPUs of the respective nodes.

10. A computer-readable storage medium, the computer-readable storage medium storing a computer program, wherein the computer program, when executed by a processor, causes the processor to:
in each of nodes, establish an independent training calculation chart, cover all of GPUs and CPUs in each of the nodes by using the training calculation chart, and add the CPUs of each of the nodes into a deep-learning-model distributed-training frame;
copy initial training parameters in GPUs of a host node into CPUs of the host node, and based on a broadcasting operation of the deep-learning-model distributed-training frame, send the initial training parameters in the CPUs of the host node to CPUs of other nodes;
copy the initial training parameters received by the CPUs of the other nodes into GPUs of the respective nodes, perform a protocolling operation to a gradient by using the training calculation chart, and copy a first-level gradient obtained after the protocolling into CPUs of the respective nodes; and
based on a global protocolling operation of the deep-learning-model distributed-training frame, perform protocolling again to the first-level gradient in the CPUs of the respective nodes, and copy a second-level gradient obtained after the protocolling into the GPUs of the respective nodes.

11. The method for multi-node distributed training according to claim 1, wherein the operation of, based on a broadcasting operation of the deep-learning-model distributed-training frame, sending the initial training parameters in the CPUs of the host node to CPUs of other nodes comprises:
by using a broadcasting operation of Horovod, broadcasting the initial training parameters into the CPUs of the other nodes.

12. The method for multi-node distributed training according to claim 1, wherein the method is suitable for all of deep-learning frames, including Tensorflow, Pytorch and MxNet, and suitable for all of accelerators for accelerating training of deep-learning models, including other ASICs such as GPU and TPU.

13. The method for multi-node distributed training according to claim 2, wherein each node comprises calculation accelerators;
in each of the calculation accelerators, all of the calculation charts are the same and include a respective set of training parameters, and the sum of the calculation charts of each of the calculation accelerators forms one complete calculation chart.

14. The method for multi-node distributed training according to claim 13, wherein the deep-learning-model distributed-training frame is a Horovod training frame, and the Horovod training frame is configured for:
ensuring that all of the calculation accelerators have the same training parameters; and
coordinating the gradients of each of the calculation accelerators to perform the protocolling operation.

15. The computer device according to claim 9, wherein in each of the nodes, establish the independent training calculation chart, and cover all of the GPUs and the CPUs in each of the nodes by using the training calculation chart comprises:
in each of the nodes, establishing an independent calculation chart in a form of Replicated, and covering all of the GPUs and the CPUs in each of the nodes by using the calculation chart.

16. The computer device according to claim 9, wherein add the CPUs of each of the nodes into the deep-learning-model distributed-training frame comprises:
adding the CPUs of each of the nodes into a Horovod training frame.

17. The computer device according to claim 9, wherein perform the protocolling operation to the gradient by using the training calculation chart comprises:
solving a sum or an average value of gradients of all of the GPUs in the node.

18. The computer device according to claim 9, wherein perform the protocolling operation to the gradient by using the training calculation chart comprises:
invoking a protocolling operation in a GPU communication library, and based on the protocolling operation, solving a sum or an average of gradients.

19. The computer device according to claim 9, wherein based on a broadcasting operation of the deep-learning-model distributed-training frame, send the initial training parameters in the CPUs of the host node to CPUs of other nodes comprises:
by using a broadcasting operation of Horovod, broadcasting the initial training parameters into the CPUs of the other nodes.

20. The computer device according to claim 9, wherein operations of the processor are suitable for all of deep-learning frames, including Tensorflow, Pytorch and MxNet, and suitable for all of accelerators for accelerating training of deep-learning models, including other ASICs such as GPU and TPU.

21. The computer-readable storage medium according to claim 10, wherein in each of the nodes, establish the independent training calculation chart, and cover all of the GPUs and the CPUs in each of the nodes by using the training calculation chart comprises:
in each of the nodes, establishing an independent calculation chart in a form of Replicated, and covering all of the GPUs and the CPUs in each of the nodes by using the calculation chart.

22. The computer-readable storage medium according to claim 10, wherein add the CPUs of each of the nodes into the deep-learning-model distributed-training frame comprises:
adding the CPUs of each of the nodes into a Horovod training frame.

23. The computer-readable storage medium according to claim 10, wherein perform the protocolling operation to the gradient by using the training calculation chart comprises:
solving a sum or an average value of gradients of all of the GPUs in the node.
